(19) United States
(12) Patent Application Publication
(10) Pub. No.: US 2008/0046382 A1
(43) Pub. Date: Feb. 21, 2008

(54) PERSONAL PRICE INDEXING BASED UPON PERSONAL SPENDING HABITS

(75) Inventor: BRENT D. METZ, DELRAY BEACH, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/456,196

(22) Filed: Jul. 8, 2006

(51) Int. Cl. G06Q 40/00

(52) U.S. Cl. 705/36 R

(57) ABSTRACT

One aspect of the present invention can include a method for computing a Personal Price Index based on personal spending habits. The method can include a step of analyzing a personal spending data set associated with at least one of an individual and household. Expenses can be categorized in accordance with expense categories, such as Consumer Price Index (CPI) based expense categories. Relative contributions of each of the expense categories can be weighed in accordance with the categorized expenses to derive personal category weights. The PPI can be calculated using the personal category weights.

### BACKGROUND

1. Field of the Invention

The present invention relates to the field of economic indices, and, more particularly, to personal price indexing based upon personal spending habits.

1. Description of the Related Art

The Consumer Price Index (CPI) also called the Retail Price Index (RPI) and/or the cost-of-living index is an index published by the Bureau of Labor Statistics (BLS) for the United States that is used to measure a change in consumer prices. The CPI is an indication of price inflation at the consumer level. More specifically, the CPI is a measure of a weighted average of prices of a specified set of goods and services purchased by wage earners in urban areas. CPI components include the costs of housing, food, transportation, and electricity. Income taxes and investment items, such as stocks, bonds, life insurance, and homes, are not included in the CPI. Different components of the CPI are weighted in accordance with national consumption patterns related to those specific components. These weights change every year as consumption patterns change.

The government, business leaders, investment counselors, software programs, economic models, and private citizens use the CPI and other price indices as guides in making economic decisions and in devising economic policies. Many employment and pension contracts are tied to changes in consumer prices as indicated by the CPI.

The problem with the CPI and other price indices is that they are designed to be used as national indicators. The CPI index does not allow a fine grained determination of a change in spending power on an individual basis, which can be significantly different from that of a national average. This is especially true as spending habits can be based upon geographic specific, income level specific, and other individualized factors. Consequently, the CPI is not a reliable measurement through which individuals can gauge the rate at which their own spending power is changing.

For example, a national average for spending records related to gasoline can be skewed towards city dwellers, who rely more upon public than private transportation. A wage earner living in an area without significant public transportation will generally consume more gasoline than a city dwelling counterpart. Further, gasoline prices can have a disproportionate effect on farmers, who rely on gasoline to operate farm equipment, to transport farm goods, and to acquire farm supplies. Additionally, state gasoline taxes vary from state-to-state which can cause gasoline prices to be appreciably more or less expensive depending on the state of residence. For all of these reasons, changing gasoline prices which can be a significant household expense, affects the overall spending power of some individuals more than others.

Other existing indices, such as the Institute for Supply Management (ISM) index, the Producer Price Index (PPI), the Consumer Confidence Index (CCI), the Index of Consumer Sentiment (ICS) and the Consumer Spending and Saving Index (CSSI) also are based upon national averages and lack a fine grained ability to make determinations on an individual basis. Industry, product, and/or commodity specific indices, such as the Wendover-Global Insight IT Spending Index, the Commodities Research Bureau (CRB) index, the Rogers Raw Material Index (RRMI), the Goldman Sachs Commodities Index (GSCI), and the Dow Jones-AIG Commodities Index (DJ-AIG), suffer the same shortcoming. Each of these indices can individually and/or collectively be used to determine changes in spending power based upon national averages. Like the CPI, these indices and derivatives and combinations thereof do not permit the determination of a change in spending power on an individual basis.

What is needed is a personal price index that more accurately and personally gauges spending power changes.

### SUMMARY OF THE INVENTION

The invention discloses a Personal Price Index (PPI), similar to a Consumer Price Index (CPI), where changes in spending power are based upon personal spending habits instead of being based exclusively upon national averages. More specifically, an individual's spending habits can be obtained from an individual's expense records. These expenses can be mapped to expense categories, such as CPI based categories. Calculations for the PPI can be similar to those of the CPI except that the present invention replaces the CPI weights with PPI weights derived from the individual's expense records. Accordingly, if a person spends a higher percentage of their income on gasoline than the national average and a lower percentage on public transportations, the PPI weight for gasoline will be greater than the analogous CPI weight; and conversely, the PPI weight for public transportation will be lower than the analogous CPI rate. The PPI can be used by individuals and software programs to accurately estimate how changes in the price of goods and services affect an individual's budget and investment portfolio.

It should be appreciated that CPI based data sources constitute one possible source of price change information and that the invention is not to be construed as limited in this regard. Any of a variety of other sources of price change information can be substituted for CPI specific values expressed in examples throughout the application. For example, a price change source used for PPI calculations can be based upon the Producer Price Index (PPI), the Consumer Confidence Index (CCI), the Index of Consumer Sentiment (ICS), the Consumer Spending and Saving Index (CSSI), the Commodities Research Bureau (CRB) index, the Rogers Raw Material Index (RRMI), the Goldman Sachs Commodities Index (GSCI), the Dow Jones-AIG Commodities Index (DJ-AIG), and the like, as well as combinations and derivations of any of these information indices and/or data sources upon which these indices are based.

The present invention can be implemented in accordance with numerous aspects consistent with the material presented herein. For example, one aspect of the present invention can include a method for computing a PPI based on personal spending habits. The method can include a step of analyzing a personal spending data set associated with at least one of an individual and household. Expenses can be categorized in accordance with different expense categories, such as CPI expense categories. Relative contributions of each of the expense categories can be weighed in accordance with the categorized expenses to derive personal category weights. A PPI can be calculated using the personal category weights.

Another aspect of the present invention can include a method for calculating an economic index. The method can calculate a variant of the CPI called a Personal Price Index (PPI) based upon specific consumption patterns associated with a set of people instead of national consumption patterns. Expense category weights can he based upon a personal expense profile established for the set of people. The personal expense profile can be automatically generated from spending records of the set of people. The set of people can be a single individual and/or a household.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for computing a Personal Price Index (PPI) in accordance with an embodiment of the inventive arrangements disclosed herein.

FIG. 2 is a flow chart of a method for computing a Personal Price Index (PPI) in accordance with an embodiment of the inventive arrangements disclosed herein.

FIG. 3 is a flow chart of a method, where a service agent can configure a system that calculates a Personal Price Index (PPI) in accordance with an embodiment of the inventive arrangements disclosed herein.

### DETAILED DESCRIPTION OF THE INVENTION

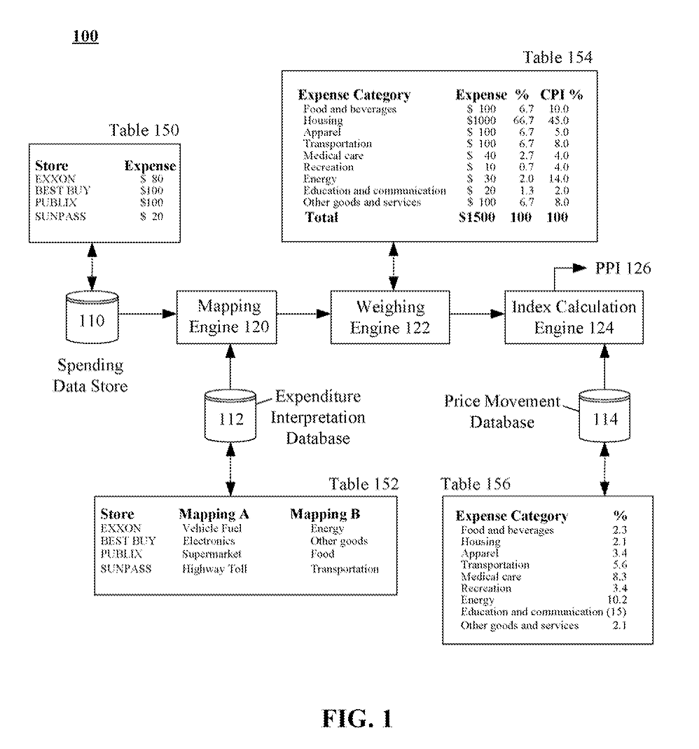

FIG. 1 is a schematic diagram of a system 100 for computing a Personal Price Index (PPI) 126 in accordance with an embodiment of the inventive arrangements disclosed herein. The PPI 126 is a personal cost-of-living index based upon personal spending habits. Unlike the Consumer Price Index (CPI), weights attributable to various expense categories that are used to calculate the PPI 126 can be based upon actual spending habits of an individual or a set of expense sharing individuals (e.g., a household) and not upon national averages. Other than the application of personal category weights, the PPI 126 can be calculated in largely the same manner and based upon the same expense categories and category price movements as those applying to the CPI. This allows the PPI 126 to utilize information and statistics gathered and maintained by the Bureau of Labor Statistics (BLS) for CPI calculations.

The PPI 126 is not limited to CPI data sources for obtaining price change information. Other data sources can be used, such as sources used to calculate the Producer Price Index (PPI), the Consumer Confidence Index (CCI), the Index of Consumer Sentiment (ICS), the Consumer Spending and Saving Index (CSSI), the Commodities Research Bureau (CRB) index, the Rogers Raw Material Index (RRMI), the Goldman Sachs Commodities Index (GSCI), the Dow Jones-AIG Commodities Index (DJ-AIG), and the like. Additionally, the price change information can be calculated based upon multiple different sources and derivatives of the same. For the sake of simplicity, CPI based data sources and expense categories are generally utilized throughout the present invention to illustrate concepts involved in calculating the PPI 126.

A first stage in generating the PPI 126 can include identifying a spending data store 110 in which spending records collectively referred to as a spending data set are recorded. The spending data set can include credit card records, debit card records, checking account records, records maintained by a personal accounting software program, banking records, and any other set of records containing individual expenditures and/or records sufficient to model personal spending habits.

Mapping engine 120 will typically be required to convert records in the data store 110 to a format appropriate for calculating the PPI 126. Just like the CPI, the PPI 126 can be calculated based upon a discrete set of expense categories, which can be identical to the expense categories used to calculate the CPI (or those expense categories used to calculate other indices upon which PPI 126 is based) or can be derived from CPI based categories. For example, multiple CPI expense categories can be grouped together (in a hierarchy) to form a parent of CPI based expense categories, which can be used to calculate PPI 126. A parent category will be at a higher granularity level than child CPI based categories. The mapping engine 120 can utilize any variety of data mining, data migration, transcoding, and format conversion tools to normalize content of data store 110 into suitable expense categories.

The mapping engine 120 can, for example, convert expenses recorded at a store-level of granularity into an appropriate expense category. As shown in table 150, expenses, such as those appearing within a credit card expense report, often include a store and an amount. For example, records based upon credit card billings can include entries for EXXON in an amount of $80, BEST BUY for $100, PUBLIX for $100, and SUNPASS for $20. Since each billing entity is associated with a particular type of good and/or service, a mapping can be performed from a store name to a PPI expense category.

Table 152 shows a sample mapping, which can be obtained from an expenditure interpretation database 112. Multiple different mappings can be provided for each store, in embodiments where different granularity levels of expense categories can be selectively used. For example, table 152 can include columns for Store, Mapping A, and Mapping B. Rows in table 152 can include entries for EXXON having an entry in Mapping A for vehicle fuel and having a higher level mapping (Mapping B) to Energy. Other illustrative rows can include BEST BUY mapped to Electronics, PUBLIX mapped to supermarket food, and SUNPASS mapped to highway tolls.

When used to map store-level expense reports to expense categories, the mapping engine 120 is not limited to a one-to-one mapping. Instead, a store can be associated with multiple expense categories, each expense category receiving a percentage of expenses attributable to that store. For example, consumers often purchase food items, cigarettes, and other goods in gas station convenient marts. Food, gas, and cigarettes can each fall into different expense categories, such as “food”, “energy” and “recreation”. Expenses attributable to EXXON can therefore be allocated across these categories, such as eight percent to food, ninety percent to energy, and two percent to recreation. Percentage allocations can be adjusted based on national shopping habits for that store, store specific sales, and/or individual shopping habits at a particular store.

The mapping engine 120 can map expenses to expense categories regardless of the granularity level at which expenses are recorded. For example, when records in the spending data store specify product-level expenses, the expenditure interpretation database 112 can map products to expense categories. Results from the mapping engine 120 can include category based expenses, which are representative of an individual's spending habits for a fixed period of time. These category level expenses can be referred to as a personal expense profile.

It should be noted that statistically accurate spending habits can be obtained from a representative sample of expenses. Consequently, the mapping engine 120 need not access and/or process a complete data set for an individual's expenses, but can instead use a subset of information. For example, if an individual's spending habits using a credit card are approximately equivalent to their spending habits in general, using credit card expenses alone can result in a relatively accurate calculation of PPI 126.

Once personal expenses have been mapped to expense categories, the weighing engine 122 can assign weights to each expense category based upon the personal expense profile. Table 154 shows a list of expense categories, a personal category percentage, and a CPI category percentage. The categories used in table 154 include food and beverages, housing, apparel, transportation, medical care, recreation, energy, education and communication, and other goods and services. These categories are relatively high-level categories, which are parent categories of CPI categories. These parent categories can be used in lieu of finer grain categories in embodiments where the expenses recorded in data store 110 cannot be accurately mapped to more fine-grained categories.

In one embodiment, the weighing engine 122 can assign a multiplier or weight called the personal category weight to each category that is exclusively based upon the personal category percentage. Weighing engine 122 can also combine this personal category percentage with other factors, such as historically gathered personal expenditure data and the CPI percentage, to compute the personal category weight. Combining multiple factors in addition to the personal category percentage can ensure that abnormalities inherent in a particular expense period do not dominate assigned personal category weights. For example, if in a three month period, an individual become uncharacteristically sick and is forced to seek medical care, the expenses related to medical care for that period will be uncharacteristically high.

The index calculation engine 124 can use the personal category weights and price movement data obtained from a price movement database 114 to generate the PPI 126. The price movement database 114 can include price movement values on a category-by-category basis. For example, and as shown by table 156, food and beverage costs may have risen for a given period by 2.3 percent, housing increased by 2.1 percent, apparel increased by 3.4 percent, transportation increased by 5.6 percent, medical care increased by 8.3 percent, recreation increased by 3.4 percent, energy increased by 10.2 percent, education decreased by 15 percent, and other goods and services could have increased by 2.1 percent. The Bureau of Labor Statistics (BLS) publishes and updates price movement values, which can be used by the index calculation engine 124 for embodiments using a CPI based data source. Other standard publications can be used for obtaining price change information for other embodiments of the present invention, where the publications used depend upon the data sources and algorithms involved in computing price changes for each expense category.

Many different algorithms can be used by the index calculation engine 124 to calculate the PPI 126. For example, the PPI 126 can be a weighed average of the categorized price movements, where the weighing is based on the personal category weights. It should be readily appreciated that any algorithm used to calculate CPI (for embodiments where expense categories are CPI based categories) can also be used to calculate the PPI 126. For example, the index calculation engine 124 can use algorithms that utilize chained weights (as is used to calculate the C-CPI-U index) or algorithms that utilize a base year (as is used to calculate the CPI-U index) to calculate the PPI 126.

Although examples provided thus far have based the PPI 126 upon an individual's expenses, the concept of the PPI 126 is not so limited. Instead, the PPI 126 can be applied to any set of people for whom spending data is available. This set of people represents a set of people having common spending habits and/or a set of people who share expenses. For example, the PPI 126 can be an indicator established for a household that includes multiple residents and one or more wage earners. In another example, the PPI 126 can be an indicator established for a communal living group, such as a fraternity/sorority consisting of multiple students who communally share many living expenses as part of their group dues. In still another example, the PPI 126 can be applied to a set of company employees, where spending records available through a company credit union can provide a reasonable estimate of employee spending habits. A company-level PPI 126 value can be tied to employee contracted benefits, which is often the case for benefit packages exempting that conventionally a CPI value is used instead of the PPI 126.

Data store 110 and databases 112-114 can be a physical or virtual storage spaces configured to store digital information. Data store 110 and databases 112-114 can be physically implemented within any type of hardware including, but not limited to, a magnetic disk, an optical disk, a semiconductor memory, a digitally encoded plastic memory, a holographic memory, or any other recording medium. Each of data store 110 and databases 112-114 can be a stand-alone storage unit as well as a storage unit formed from a plurality of physical devices. Additionally, information can be stored within each of data store 110 and databases 112-114 in a variety of manners. For example, information can be stored within a relational database structure or can be stored within one or more files of a file storage system, where each file may or may not be indexed for information searching purposes. Further, each of data store 110 and databases 112-114 can utilize one or more encryption mechanisms to protect stored information from unauthorized access.

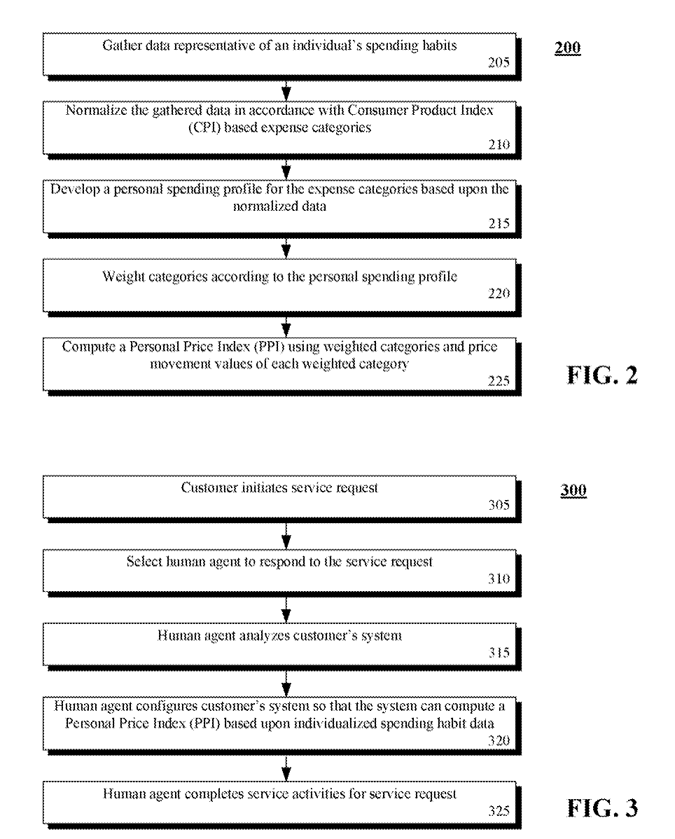

FIG. 2 is a flow chart of a method 200 for computing a PPI in accordance with an embodiment of the inventive arrangements disclosed herein. Method 200 can be performed in the context of system 100.

Method 200 can begin in step 205, wherein data representative of an individual's spending habits can be gathered. In step 210, the gathered data can be normalized in accordance with expense categories. In step 215, a personal spending profile for the expense categories can be developed based upon the normalized data. The personal spending profile can show a relative percentage spent for each expense category within a defined period of time. The period of time should be sufficient to predict spending habits of the individual. In step 220, categories can be weighed according to the personal spending profile. In step 225, a personal price index can be computed using personal category weights and price movement values for each category. Each price movement value can show how the price for items of that expense category have increased and/or decreased since a base time period.

FIG. 3 is a flow chart of a method 300, where a service agent can configure a system that calculates a PPI in accordance with an embodiment of the inventive arrangements disclosed herein. Method 300 can be performed in the context of system 100 or a method 200.

Method 300 can begin in step 305, when a customer initiates a service request. The service request can be a request for a service agent to configure or troubleshoot a software system that calculates or uses a PPI. In step 310, a human agent can be selected to respond to the service request. In step 315, the human agent can analyze a customer's current system and can develop a solution. In step 320, the human agent can configure the client system so that the system can generate and/or utilize a personal price index. For example, the human agent can link the client's system to a personal spending data store and to a data source for Bureau of Labor Statistics (BLS) CPI data. The human agent can also map data from a financial accounting program, an online banking source, or other source of personal spending information so that a PPI can be automatically calculated based upon the mapped data. In one embodiment, the automatically calculated PPI can be a parameter used by another client program, such as an investment management program. In step 325, the human agent can complete the service activities.

It should be noted that while the human agent may physically travel to a location local to adjust the customer's computer or application server, physical travel may be unnecessary. For example, the human agent can use a remote agent to remotely manipulate the customer's computer system.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for computing a personal price index (PPI) comprising:
analyzing a personal spending data set associated with at least one of an individual and household;
categorizing expenses in the data set in accordance with expense categories;
weighing relative contributions of each of the expense categories in accordance with the categorized expenses to derive personal category weights; and
calculating a personal price index utilizing the personal category weights.

2. The method of claim 1, wherein each of the expense categories is a Consumer Price Index based category, wherein the calculating step utilizes a Consumer Price Index calculation algorithm to calculate the personal price index, wherein when the algorithm is used to calculate the personal price index, the personal category weights are used by the Consumer Price Index calculation algorithm instead of Consumer Price Index category weights.

3. The method of claim 1, wherein entries included in the personal data set include expenditures recorded on a per-store basis, wherein said categorizing step:
queries a database that relates a plurality of stores to expense categories, and wherein the expenditures are assigned to expense categories in accordance with results from the database queries.

4. The method of claim 3, wherein the database relates one of the stores to a plurality of different expense categories, each related category corresponding to a store expenditure percentage, wherein the expenditures for that store are assigned to the different expense categories in accordance with the assigned percentage.

5. The method of claim 1, wherein entries included in the personal data set include expenditures recorded on a per-item basis, wherein said categorizing step:
queries a database that relates a plurality of items to expense categories, and wherein the expenditures are assigned to expense categories in accordance with results from the database queries.

6. The method of claim 1, further comprising:
establishing a plurality of expense categories, each established expense category being a parent to a plurality of grouped expense categories, wherein said expense categories of the categorizing step comprise the established expense categories.

7. The method of claim 1, further comprising:
determining component indexes for each of the expense categories, wherein each component index represents price movements for one of the expense categories, wherein the calculating step utilizes the component indexes to calculate the personal price index.

8. The method of claim 7, wherein the component indexes are directly derived from published indexes used to calculate the Consumer Price Index.

9. The method of claim 7, wherein each Consumer Price Index based category and each component index are directly derived from categories and values established and updated by the Bureau of Labor Statistics (BLS).

10. The method of claim 7, wherein each of the component indexes is a chained index.

11. The method of claim 7, wherein each of the component indexes is computed from values for an associated Consumer Price Index category recorded in a base year.

12. The method of claim 1, wherein the personal spending data comprise at least one of credit card records, debit card records, online banking records, and a personal accounting software package.

13. The method of claim 1, wherein the steps of claim 1 are performed by at least one of a service agent and a computing device manipulated by the service agent, the steps being performed in response to a service request.

14. A machine-readable storage having stored thereon, a computer program having a plurality of code sections, said code sections executable by a machine for causing the machine to perform the steps of:
analyzing a personal spending data set associated with at least one of an individual and household;
categorizing expenses in the data set in accordance with expense categories;
weighing relative contributions of each of the expense categories in accordance with the categorized expenses to derive personal category weights; and
calculating a personal price index utilizing the personal category weights.

15. A method for calculating an economic index comprising:
calculating a variant of a standardized spending habit index called a Personal Price Index (PPI) based upon specific consumption patterns associated with a set of people instead of national consumption patterns, wherein expense category weights for the personal price index are based upon a personal expense profile established for the set of people.

16. The method of claim 15, wherein the standardized spending habit index is a Consumer Price Index based index.

17. The method of claim 15, wherein the set of people consists of at least one of an individual and a group of people associated with a household.

18. The method of claim 15, wherein the personal expense profile is automatically constructed based upon spending records associated with the set of people.

19. The method of claim 18, wherein the spending records comprise at least one of credit card records, debit card records, online banking records, and a personal accounting software package.

20. The method of claim 15, wherein the steps of claim 15 are performed by at least one of a service agent and a computing device manipulated by the service agent, the steps being performed in response to a service request.
